(19) United States
(12) Patent Application Publication
(10) Pub. No.: US 2024/0154817 A1
(43) Pub. Date: May 9, 2024

(54) MEMORY MANAGEMENT IN A COMPUTER SYSTEM CONFIGURED FOR GENERATING A SIGNATURE AND APPARATUS FOR IMPLEMENTING THE SAME

(71) Applicants: BULL SAS, Rue Jean Jaurès (FR); UNIVERSITE GRENOBLE ALPES, SAINT MARTIN D'HERES (FR); CENTRE NATIONAL DE LA RECHERCHE SCIENTIFIQUE, PARIS (FR)

(72) Inventors: Etienne MARCATEL, PLAISIR (FR); Kevin LEBRET, CONFLANS SAINTE HONORINE (FR); Philippe ELBAZ-VINCENT, RODEZ FRANCE (FR)

(73) Assignees: BULL SAS, LES CLAYES SOUS BOIS (FR); UNIVERSITE GRENOBLE ALPES, SAINT MARTIN D'HERES (FR); CENTRE NATIONAL DE LA RECHERCHE SCIENTIFIQUE, PARIS (FR)

(21) Appl. No.: 18/376,940

(22) Filed: Oct. 5, 2023

(30) Foreign Application Priority Data
Oct. 6, 2022 (EP) 22306500.4

(51) Int. Cl. H04L 9/32

(52) U.S. Cl. CPC H04L 9/3247

(57) ABSTRACT

A computer-implemented method for memory management in a computer system configured for generating a signature of a binary data message m using a key B of a predetermined lattice-based structure is proposed, which comprises: determining coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials; and determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; wherein the storing in a memory buffer of the computer system of the coefficients of the signature generation matrix SG and the coefficients of the matrices of the LDL representation is managed based on that the signature generation matrix SG has real diagonal coefficients, and the memory buffer is used alternatively to store the coefficients of the signature generation matrix SG or the coefficients of the matrix D of the LDL representation.

### CROSS-REFERENCE TO RELATED APPLICATIONS

This application claims priority benefit under 35 U.S.C. § 119(d) from European Patent Application No. 22 306 500.4, filed Oct. 6, 2022, the disclosure of which is incorporated by reference herein in its entirety.

### FIELD

The present subject disclosure relates to the field of post-quantum cryptography, in particular to the management of memory space used for implementing a signature generation algorithm.

### BACKGROUND

With the worldwide efforts to develop quantum computer, the so-called post-quantum cryptography (PQC) has become a subject of the utmost importance. To prepare a smooth transition from nowadays cryptography to this new paradigm, the NIST started a standardization process for Key Encapsulation Mechanism and Digital Signature in 2017 with the goal of selecting PQC algorithms suitable for real-world deployment.

Among all the candidates, lattice-based propositions appear as the best trade-off between computational and bandwidth efficiency. Both lattice-based signatures achieve reasonable public key and signature sizes, but the most compact is the so-called “Falcon” (“Fast-Fourier Lattice-based Compact Signatures over NTRU”) cryptographic signature algorithm. A detailed description of the Falcon algorithm can be found in the paper entitled “FALCON Fast-Fourier Lattice-based Compact Signatures over NTRU” available at the URL https://falcon-sign.info/.

The Falcon design is considered the most size-efficient and it has been shown that its verification algorithm fits in 8 KB of RAM. However, the memory footprint to perform the signature is an order of magnitude larger. While this might not be a problem for many platforms where large areas of memory are cheaply available, it can become a problem when the cryptosystem is deployed on constrained devices where the memory is an expensive resource.

### SUMMARY

There is therefore a need for an improved method for managing the memory used for generating a signature of a binary data message m using a key B of a predetermined lattice-based structure that addresses the drawbacks and shortcomings of the conventional technology in the art.

In particular, it is an object of the present subject disclosure to provide an improved method for memory management in a computer system configured for generating a signature of a binary data message m using a key B of a predetermined lattice-based structure that addresses the drawbacks and shortcomings of the conventional technology in the art.

To achieve these objects and other advantages and in accordance with the purpose of the present subject disclosure, as embodied and broadly described herein, in one aspect of the present subject disclosure, a computer-implemented method for memory management in a computer system configured for generating a signature of a binary data message m using a key B of a predetermined lattice-based structure is proposed.

The proposed method may comprise: determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials; determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and managing the storing in a memory buffer of the computer system of the coefficients of the signature generation matrix SG and the coefficients of the matrices of the LDL representation based on that (a) the signature generation matrix SG has real diagonal coefficients, and/or (b) the memory buffer is used alternatively to store the coefficients of the signature generation matrix SG or the coefficients of the matrix D of the LDL representation.

In some embodiments, the proposed method may comprise: determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials; determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and managing the storing in a memory buffer of the computer system of the coefficients of the signature generation matrix SG and the coefficients of the matrices of the LDL representation based on at least one of: (a) the signature generation matrix SG has real diagonal coefficients, and (b) the memory buffer is used alternatively to store the coefficients of the signature generation matrix SG or the coefficients of the matrix D of the LDL representation.

In some embodiments, the proposed method may comprise: determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials; determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and managing the storing in a memory buffer of the computer system of the coefficients of the signature generation matrix SG and the coefficients of the matrices of the LDL representation based on that the signature generation matrix SG has real diagonal coefficients.

In some embodiments, the proposed method may comprise: determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials; determining a LDL representation of the signature generation matrix SG according to which SG is represented by a matrix product L. D.L*, wherein L is a 2×2 lower triangular matrix with ones on the diagonal, D is a 2×2 diagonal matrix, and L* is the adjoint of L; and managing the storing in a memory buffer of the computer system of the coefficients of the signature generation matrix SG and the coefficients of the matrices of the LDL representation based on that the memory buffer is used alternatively to store the coefficients of the signature generation matrix SG or the coefficients of the matrix D of the LDL representation.

In some embodiments, the proposed method may comprise: determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials; determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and managing the storing in a memory buffer of the computer system of the coefficients of the signature generation matrix SG and the coefficients of the matrices of the LDL representation by using the memory buffer alternatively to store the coefficients of the signature generation matrix SG or the coefficients of the matrix D of the LDL representation.

In one or more embodiments, the memory buffer is dimensioned for storing complex non-diagonal coefficients and real diagonal coefficients of the signature generation matrix SG. In some embodiments, the memory buffer may be limited in size to what is required for storing complex non-diagonal coefficients and real diagonal coefficients of the signature generation matrix SG. This advantageously reduces the size of the memory space required for implementing a signature algorithm such as according to the Falcon scheme, thereby allowing implementations on embedded systems with very limited memory space.

In one or more embodiments, the diagonal matrix

$$D = ( \begin{matrix}{d}_{00} & 0 \\ 0 & {d}_{11}\end{matrix} )$$

may be determined as:

$$( \begin{matrix}{g}_{00} & 0 \\ 0 & {g}_{11} - \frac{{\vert {g}_{01} \vert}^{2}}{{g}_{00}}\end{matrix} ) ,$$

where the signature generation matrix

$$S G = ( \begin{matrix}{g}_{00} & {g}_{01} \\ {g}_{10} & {g}_{11}\end{matrix} ) ,$$

where g₀₀ and g₁₁ are real polynomials, and g₁₀ and g₀₁ are complex polynomials.

In one or more embodiments, the key B may have a matrix structure, and the signature generation matrix may further be determined based on the matrix product B.B*, wherein B* is the adjoint matrix of B.

In one or more embodiments, the key B may have a matrix structure, and the signature generation matrix may be determined based on the matrix product \hat{B}.\hat{B}*, wherein \hat{B}* is the adjoint matrix of \hat{B}, and wherein \hat{B} is obtained based on a transform of the matrix B in a frequency domain.

In one or more embodiments, the matrix L may be of the form

$$( \begin{matrix}1 & 0 \\ {l}_{10} & 1\end{matrix} ) ,$$

and the proposed method may further comprise: computing the coefficient l₁₀ of the matrix L as

$${l}_{10} = \frac{\overline{{g}_{01}}}{{g}_{00}} ,$$

wherein the signature generation matrix SG is of the form

$$( \begin{matrix}{g}_{00} & {g}_{01} \\ {g}_{10} & {g}_{11}\end{matrix} ) ,$$

where g₀₀ and g₁₁ are real polynomials, and g₁₀ and g₀₁ are complex polynomials, and wherein the computing the coefficient l₁₀ of the matrix L comprises: computing the inverse 1/g₀₀ of the real coefficient g₀₀, and performing a real-complex multiplication of 1/g₀₀ with the complex polynomial g̅₀̅₁̅.

In one or more embodiments, the signature generation matrix SG may be determined to be of the form:

$$( \begin{matrix}{g}_{00} & {g}_{01} \\ \overline{{g}_{01}} & {g}_{00}\end{matrix} ) ,$$

wherein g₀₀ is a real polynomial, g₀₁ is a complex polynomial, and g̅₀̅₁̅ is the complex conjugate of g₀₁. Further, the memory buffer may be dimensioned for storing g₀₀ and the real and imaginary parts of g₀₁. In some embodiments, the memory buffer may be limited in size to what is required for storing g₀₀ and the real and imaginary parts of g₀₁. This also advantageously reduces the size of the memory space required for implementing a signature algorithm such as according to the Falcon scheme, thereby allowing implementations on embedded systems with very limited memory space.

In one or more embodiments, the signature generation matrix may be a Gram matrix of size 2×2.

In one or more embodiments, the signature generation matrix SG may be of the form

$$( \begin{matrix}{g}_{00} & {g}_{01} \\ {g}_{10} & {g}_{11}\end{matrix} ) ,$$

where g₀₀ and g₁₁ are real polynomials, and g₁₀ and g₀₁ are complex polynomials, wherein g₁₀ is equal to the complex conjugate g̅₁̅₀̅ of g₀₁. Further, the memory buffer may be dimensioned to store real polynomials corresponding to g₀₀, g₁₁, and the real and imaginary parts of g₀₁. The diagonal matrix

$$D = ( \begin{matrix}{d}_{00} & 0 \\ 0 & {d}_{11}\end{matrix} )$$

may be determined as:

$$( \begin{matrix}{g}_{00} & 0 \\ 0 & {g}_{11} - \frac{{\vert {g}_{01} \vert}^{2}}{{g}_{00}}\end{matrix} ) ,$$

and the coefficient d₁₁ may be stored in the memory buffer by overwriting one or more coefficients of the signature generation matrix SG. In some embodiments, the memory buffer may be limited in size to what is required for storing g₀₀ and the real and imaginary parts of g₀₁, and the same memory buffer may advantageously be used for storing the coefficient d₁₁ by overwriting one or more coefficients of the signature generation matrix SG. This also advantageously further reduces the size of the memory space required for implementing a signature algorithm such as according to the Falcon scheme, thereby allowing implementations on embedded systems with very limited memory space.

In one or more embodiments, the proposed method may further comprise: generating a signature s₂ of the message m based on the determination of the coefficients of the signature generation matrix SG, and the determination of the LDL representation of the signature generation matrix SG.

In one or more embodiments, the key B may be of the form

$$( \begin{matrix}g & - f \\ G & - F\end{matrix} ) ,$$

wherein f, g, F, and G are polynomials of [symbol] [x]/Φ_{κ}), where Φ_{κ}=xⁿ+1∈ [symbol] [x] for n=2^{κ}, and κ be a positive integer which verify the equation f·G−g·F=q mod(Φ_{κ}), where q is a constant equal to 12×2¹⁰+1 (that is, q=12289).

According to another aspect of the present subject disclosure, an apparatus (e.g. a processing node in a computer system) is proposed, which comprises a processor, and a memory operatively coupled to the processor. The proposed apparatus is configured to perform embodiments of the proposed method according to the present subject disclosure.

According to yet another aspect of the present subject disclosure, a non-transitory computer-readable medium encoded with executable instructions which, when executed on a computer, causes a processor of the non-quantum computer, that is operatively coupled with a memory, to perform embodiments of the proposed method according to the present subject disclosure, is proposed.

For example, in embodiments, the present subject disclosure provides a non-transitory computer-readable medium encoded with executable instructions which, when executed, causes an apparatus comprising a processor operatively coupled with a memory, to manage memory in a computer system configured for generating a signature of a binary data message m using a key B of a predetermined lattice-based structure, by performing the determining, by the processor, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials; determining, by the processor, a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and managing, by the processor, the storing in a memory buffer of the computer system of the coefficients of the signature generation matrix SG and the coefficients of the matrices of the LDL representation based on at least one of: (a) the signature generation matrix SG has real diagonal coefficients, and (b) the memory buffer is used alternatively to store the coefficients of the signature generation matrix SG or the coefficients of the matrix D of the LDL representation.

According to yet another aspect of the present subject disclosure, a computer program product comprising computer program code tangibly embodied in a computer readable medium, said computer program code comprising instructions to, when provided to a computer system and executed, cause said computer system to perform embodiments of the proposed method according to the present subject disclosure, is proposed.

In another aspect of the present subject disclosure, a data set representing, for example through compression or encoding, a computer program as proposed herein, is proposed.

It should be appreciated that the present subject disclosure can be implemented and utilized in numerous ways, including without limitation as a process, an apparatus, a system, a device, and as a method for applications now known and later developed. These and other unique features of the system disclosed herein will become more readily apparent from the following description and the accompanying drawings.

### BRIEF DESCRIPTION OF THE DRAWINGS

The present subject disclosure will be better understood and its numerous objects and advantages will become more apparent to those skilled in the art by reference to the following drawings, in conjunction with the accompanying specification, in which:

FIG. 1 illustrates an exemplary algorithm for computing a Fast Fourier Transform of a polynomial according to the Falcon signature scheme, in accordance with one or more embodiments;

FIG. 2a illustrates an exemplary algorithm for computing a split of a polynomial into two polynomials according to the Falcon signature scheme, in accordance with one or more embodiments;

FIG. 2b illustrates an exemplary algorithm for computing a merge of two or more polynomials into one polynomial according to the Falcon signature scheme, in accordance with one or more embodiments;

FIG. 3 illustrates an exemplary algorithm for generating keys according to the Falcon signature scheme, in accordance with one or more embodiments;

FIG. 4 illustrates an exemplary algorithm for computing a “Falcon tree” according to the Falcon signature scheme, in accordance with one or more embodiments;

FIG. 5 illustrates an exemplary algorithm for key expansion according to the Falcon signature scheme, in accordance with one or more embodiments;

FIG. 6a illustrates an exemplary algorithm for message signature according to the “tree variant” of the Falcon signature scheme, in accordance with one or more embodiments;

FIG. 6b illustrates an exemplary algorithm for fast Fourier sampling (tree variant) according to the Falcon signature scheme, in accordance with one or more embodiments.

FIG. 6c illustrates an exemplary algorithm for message signature according to the “dynamic variant” of the Falcon signature scheme, in accordance with one or more embodiments;

FIG. 7a illustrates an exemplary algorithm for fast Fourier sampling (dynamic variant) according to the Falcon signature scheme, in accordance with one or more embodiments.

FIG. 7b is a flowchart illustrating an exemplary algorithm for fast Fourier sampling (dynamic variant) according to the Falcon signature scheme, in accordance with one or more embodiments.

FIG. 8 illustrates an exemplary algorithm for signature verification according to the Falcon signature scheme, in accordance with one or more embodiments.

FIG. 9a illustrates an exemplary algorithm for computing a split of a real polynomial into two real polynomials, in accordance with one or more embodiments;

FIG. 9b is a block diagram illustrating an exemplary memory management method, in accordance with one or more embodiments;

FIG. 10 is a diagram illustrating an exemplary architecture of a computer system for implementing the proposed method, in accordance with one or more embodiments.

### DETAILED DESCRIPTION

The advantages, and other features of the components disclosed herein, will become more readily apparent to those having ordinary skill in the art form. The following detailed description of certain preferred embodiments, taken in conjunction with the drawings, sets forth representative embodiments of the subject technology, wherein like reference numerals identify similar structural elements.

For simplicity and clarity of illustration, the drawing figures illustrate the general manner of construction, and descriptions and details of well-known features and techniques may be omitted to avoid unnecessarily obscuring the discussion of the described embodiments of the subject disclosure. Additionally, elements in the drawing figures are not necessarily drawn to scale. For example, the dimensions of some of the elements in the figures may be exaggerated relative to other elements to help improve understanding of embodiments of the present subject disclosure. Certain figures may be shown in an idealized fashion in order to aid understanding, such as when structures are shown having straight lines, sharp angles, and/or parallel planes or the like that under real-world conditions would likely be significantly less symmetric and orderly.

In addition, it should be apparent that the teaching herein can be embodied in a wide variety of forms and that any specific structure and/or function disclosed herein is merely representative. In particular, one skilled in the art will appreciate that an aspect disclosed herein can be implemented independently of any other aspects and that several aspects can be combined in various ways.

The present disclosure is described below with reference to functions, engines, block diagrams and flowchart illustrations of the methods, systems, and computer program according to one or more exemplary embodiments. Each described function, engine, block of the block diagrams and flowchart illustrations can be implemented in hardware, software, firmware, middleware, microcode, or any suitable combination thereof. If implemented in software, the functions, engines, blocks of the block diagrams and/or flowchart illustrations can be implemented by computer program instructions or software code, which may be stored or transmitted over a computer-readable medium, or loaded onto a general purpose non quantum computer, special purpose non quantum computer or other programmable data processing apparatus to produce a machine, such that the computer program instructions or software code which execute on the non-quantum computer or other programmable data processing apparatus, create the means for implementing the functions described herein.

Embodiments of computer-readable media includes, but are not limited to, both computer storage media and communication media including any medium that facilitates transfer of a computer program from one place to another. As used herein, a “computer storage media” may be any physical media that can be accessed by a computer. Examples of computer storage media include, but are not limited to, a flash drive or other flash memory devices (e.g. memory keys, memory sticks, key drive), CD-ROM or other optical storage, DVD, magnetic disk storage or other magnetic storage devices, memory chip, RAM, ROM, EEPROM, smart cards, Solid State Drive (SSD) devices or Hard Disk Drive (HDD) devices, or any other suitable medium from that can be used to carry or store program code in the form of instructions or data structures which can be read by a computer processor. Also, various forms of computer-readable media may transmit or carry instructions to a computer, including a router, gateway, server, or other transmission device, wired (coaxial cable, fiber, twisted pair, DSL cable) or wireless (infrared, radio, cellular, microwave). The instructions may comprise code from any computer-programming language, including, but not limited to, assembly, C, C++, Visual Basic, HTML, PHP, Java, Javascript, Python, and bash scripting.

Unless specifically stated otherwise, it will be appreciated that throughout the following description discussions utilizing terms such as processing, computing, calculating, determining, generating, or the like, refer to the action or processes of a computer or computing system, or similar electronic computing device, that manipulate or transform data represented as physical, such as electronic, quantities within the registers or memories of the computing system into other data similarly represented as physical quantities within the memories, registers or other such information storage, transmission or display devices of the computing system.

The terms “comprise,” “include,” “have,” and any variations thereof, are intended to cover a non-exclusive inclusion, such that a process, method, article, or apparatus that comprises a list of elements is not necessarily limited to those elements but may include other elements not expressly listed or inherent to such process, method, article, or apparatus.

Additionally, the word “exemplary” as used herein means serving as an example, instance, or illustration. Any aspect or design described herein as “exemplary” is not necessarily to be construed as preferred or advantageous over other aspects or designs.

In the following description and claims, the notation “|0>” designates the quantum state “ket-zero” that may be used as an initial quantum state in embodiments of the present subject disclosure.

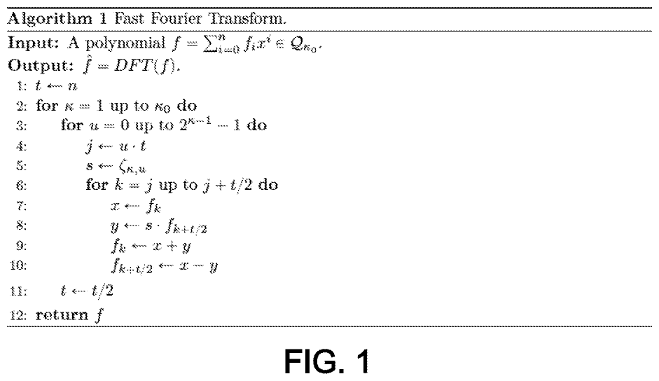

In the following, a description of the Falcon signature scheme, including some of the algorithms specified for Falcon is provided. Further details on Falcon, including on the algorithms illustrated by FIGS. 1, 2a, 2b, 3, 4, 5, 6a, 6b, and 7, may be found in the document “FALCON: Fast-Fourier Lattice-based Compact Signatures over NTRU Specifications v1.0”, which is available at the following URL: https://www.di.ens.fr/˜prest/Publications/falcon.pdf. In the following, embodiments of the proposed methods, apparatuses and computer programs are described in the exemplary context of the Falcon signature scheme. The methods proposed in the present subject disclosure may be implemented by any computer system comprising a processor configured for generating a signature of a binary data message m, such as, for example a computer system configured for implementing a signature scheme compliant with the Falcon specification(s) or any related standard(s), whether in their existing versions and/or their evolutions, as the case may be adapted for implementing one or more embodiments of the proposed methods.

However, it will be appreciated by those having ordinary skill in the relevant art that embodiments provided in the present subject disclosure may be used in any other suitable signature scheme context in place of or in addition to the Falcon signature scheme which is given by way of example only. Further, even though the following focuses on a non-limiting example based on the Falcon specification, a person of ordinary skill in the art would understand that the proposed processes, apparatuses and computer programs of the present subject disclosure may be implemented based on any suitable message signature scheme, and that such proposed processes, apparatuses and computer programs of the present subject disclosure are not limited to the use of any specific signature scheme, and in particular to the Falcon signature scheme, which is provided as an example only.

Falcon is a Lattice-based digital signature scheme relying on the Hash-and-Sign paradigm and more precisely on the so-called “GPV framework” established by Gentry et al. in the paper entitled “Trapdoors for hard lattices and new cryptographic constructions” (Proceedings of the fortieth annual ACM symposium on Theory of computing, pages 197-206, 2008). The main idea of the GPV framework is to have a private and a public basis of the same q-ary lattice. The private basis is used for trapdoor sampling, namely, sampling of lattice vector close to a given target vector, and the public basis is used by the verifier to check if a given vector is indeed a lattice point.

The Falcon procedure to sign a binary data message m includes the following operations: the message m is first hashed to a vector, and a pre-image is computed via basic linear algebra. Then the private basis is used to sample a close lattice point. Finally, the verifier just needs to check if the given signature is small and if it is a lattice point.

To instantiate the GPV framework, Falcon designers chose the NTRU families to favor compactness and to rely on a fast Fourier sampling for the trapdoor function.

Let κ be a positive integer. Set Φ_{κ}=xⁿ+1∈ [symbol] [x] for n=2^{κ}. It is the 2n-th cyclotomic polynomial, whose roots are ζ₂ₙ^{k} with ζ₂ₙ=e^{iπ/n} and k an odd positive integer. Let Q_{κ}= [symbol] [x]/(Φ_{κ}) be the 2n-th cyclotomic field. In the following, the parameter κ may be omitted when it is clear from context.

For any polynomial a=Σᵢ₌₀ⁿ⁻¹aᵢxⁱ∈Q, we call the “adjoint” of a, noted a*, the unique element of Q such that for any root ζ or Φ, we have a*(ζ)=a̅(̅ζ̅)̅ for the usual complex conjugation. Since Φ is a cyclotomic polynomial, we have:

$${a}^{*} = {a}_{0} - {\sum }_{i = 1}^{n - 1} {a}_{i} {x}^{n - 1} .$$

This definition can be extended to vectors and matrices by applying the adjoint component-wise to the transpose of vectors and matrices.

We can now define a metric over Q with the inner product [symbol] .,. [symbol] and its associated norm ∥.∥, follows: For a, b∈Q,

$$〈 a , b 〉 = {\sum }_{i = 0}^{n - 1} {a}_{i} {b}_{i} = \frac{1}{deg Φ} {\sum }_{Φ ( ζ ) = 0} a ( ζ ) \overline{b ( ζ )}$$

and

∥a∥=\sqrt{a,a}.

The scalar product definition can be naturally extended to vectors over Q: For u, v∈Q^{l},

[symbol]

u,v [symbol] =Σᵢ₌₀^{l-1} [symbol] uᵢ,vᵢ

[symbol]

Let B be a full rank two-by-two matrix over Q. We can decompose B as a unique matrix product B=L.\tilde{B}, where L is a lower triangular matrix with ones on the diagonal, and where distinct rows of \tilde{B} are orthogonal. This decomposition is known as the “Gram-Schmidt decomposition”, and we can define the following value:

∥B∥_{GS}= [symbol] ∥\tilde{B}ₗ∥

However, for efficiency reason, Falcon uses the so-called “LDL decomposition”. Let G=B.B* be the Gram matrix of B. We can write G as a unique matrix product L.D.L*, with L being a lower triangular matrix with ones on the diagonal, and D being a diagonal matrix.

Both decompositions are equivalent. In particular, the L matrices in both decompositions are equal.

In addition, ∥B∥_{GS} can be computed from the square root of the coefficients of D.

$$For G = ( \begin{matrix}{g}_{00} & {g}_{01} \\ {g}_{10} & {g}_{11}\end{matrix} ) ,$$

$$we have D = ( \begin{matrix}{d}_{00} & 0 \\ 0 & {d}_{11}\end{matrix} ) = ( \begin{matrix}{g}_{00} & 0 \\ 0 & {g}_{11} - \frac{{\vert {g}_{01} \vert}^{2}}{{g}_{00}}\end{matrix} ) ,$$

$$and L = ( \begin{matrix}1 & 0 \\ \frac{\overline{{g}_{01}}}{{g}_{00}} & 1\end{matrix} ) .$$

The Discrete Fourier Transform is a widely used technique to achieve fast polynomial arithmetic. Indeed, it may be used for linear polynomial addition, multiplication, and division. While the naïve complexity of the transformation is O(n²), the power-of-two cyclotomic structure of Φ fortunately allows to use the Fast Fourier Transform introduced by Cooley-Tukey with a quasi-linear complexity of O(n log n). FIG. 1 illustrates an exemplary iterative description of the Cooley-Tukey FFT. For the sake of simplicity, the exact value of the twiddle factors in line 5 which are precomputed is omitted, and their order are explicated only when needed.

The inverse operation, noted iFFT, and referred to as “inverse Fast Fourier Transform”, may be described in a similar manner as the FFT operation, with κ ranging from κ₀ to 1, t ranging from 1 to n, by reverting the butterfly on the innermost loop. One can note that the iFFT algorithm may use the Gentleman-Sande butterfly.

For f∈Q, the image of f by the FFT transform may be said as being on the “FFT domain”, and may be noted as \hat{f}, and conversely the original f may be said as being on the “classical domain”. In the following, the notation “\hat{ }” may be omitted if it is clear from the context that the polynomial is (or is not) on the FFT domain.

The FFT representation of a Q polynomial is redundant since for f∈Q, we have f(ζ̅)=f̅(̅ζ̅)̅. As a consequence, only n/2 complex numbers are needed to store the image \hat{f} by a FFT transform of an original f∈Q.

The signing operation of the Falcon scheme may use an operation to split an element of Q_{κ} into two elements of Q_{κ-1}. The splitting of an element of Q_{κ} may be based on that, by its very definition, Φ_{κ}(x)=Φ_{κ-1}(x²).

Conversely, two elements of [symbol] [x]/(Φ_{κ-1}) may be merged into one element of [symbol] [x]/(Φ_{κ}).

For example, the split of a polynomial f=Σᵢ₌₀ⁿ⁻¹aᵢxⁱ of Q_{κ} may be obtained by defining two polynomials of Q_{κ-1}, such that f(x)=f₀(x²)+xf₁(x²), as follows:

f₀(x)=Σᵢ₌₀^{n/2-1}a₂ᵢxⁱ and f₁(x)=Σᵢ₌₀^{n/2-1}a₂ᵢ₊₁xⁱ

In the following, the split of the polynomial f of Q_{κ} is noted split(f)=(f₀, f₁), and conversely the merge of the two polynomials f₀ and f₁ into the polynomial f may be noted f=merge(f₀, f₁).

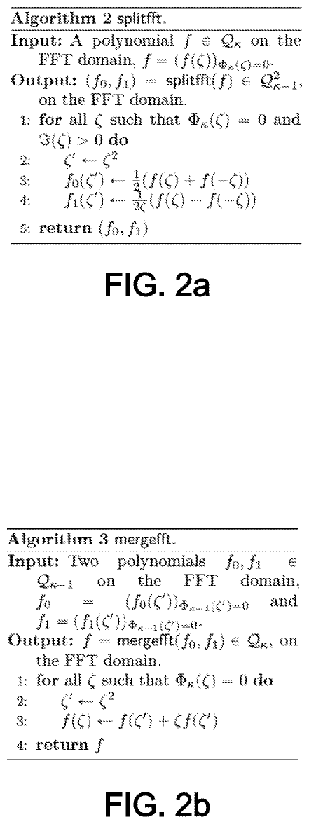

Once f is on the FFT domain, it costs O(n log n) to transform it back on the classical domain. Therefore it may be advantageous to compute the split and merge operations in the FFT domain. To do so, a splitfft function defined by splitfft(FFT(f)=FFT(split(f)) and a mergefft function defined by mergefft (FFT(f₀), FFT(f₁))=FFT(merge(f₀, f₁)). Examples of algorithms for implementing the splitfft and mergefft functions are provided by the algorithms of FIG. 2a and FIG. 2b, respectively.

The fft algorithm shown on FIG. 1 computes the Fast Fourier Transform f of an input polynomial of degree n.

The splitfft algorithm shown on FIG. 2a splits an input complex polynomial f into two complex polynomials f₀ and f₁.

The mergefft algorithm shown on FIG. 2b merges two (or more) input polynomials f₀ into one polynomial.

We note Z= [symbol] [x]/(Φ) the ring of integers of Q and q=12289.

A NTRU family is defined as a quadruplet (f, g, F, G)∈Z⁴ such that the following NTRU equation holds:

fG−gF=qmodϕ

Furthermore, the polynomials f and g may advantageously be chosen “small”, and the polynomial f may be chosen to be invertible modulo q so that h←g/f mod q can be computed. Then h can be used as a public key, while the NTRU family can be used as a private key, as it can be checked that

$$( \begin{matrix}1 & h \\ 0 & q\end{matrix} ) and ( \begin{matrix}f & g \\ F & G\end{matrix} )$$

generate the very same lattice.

The security of the scheme relies on the fact that h and q are large polynomials unsuited for trapdoor sampling. Moreover, it is hard to find small polynomials f′ and g′ such that h=g′/f′. The hardness of this problem is known as the NTRU assumption.

As provided by the Key Generation scheme of Falcon, the polynomials f and g are first sampled using integer gaussian sampling. Then the scheme checks if f is invertible. In the case where f is invertible, h is computed. Otherwise, in the case where f is not invertible, f and g are rejected and new polynomials are sampled. Finally, the NTRU equation is solved.

However, the NTRU equation does not necessarily have a solution, and the polynomials F and G might be too big to perform trapdoor sampling. In any of those two cases, f and g are rejected and new polynomials are sampled.

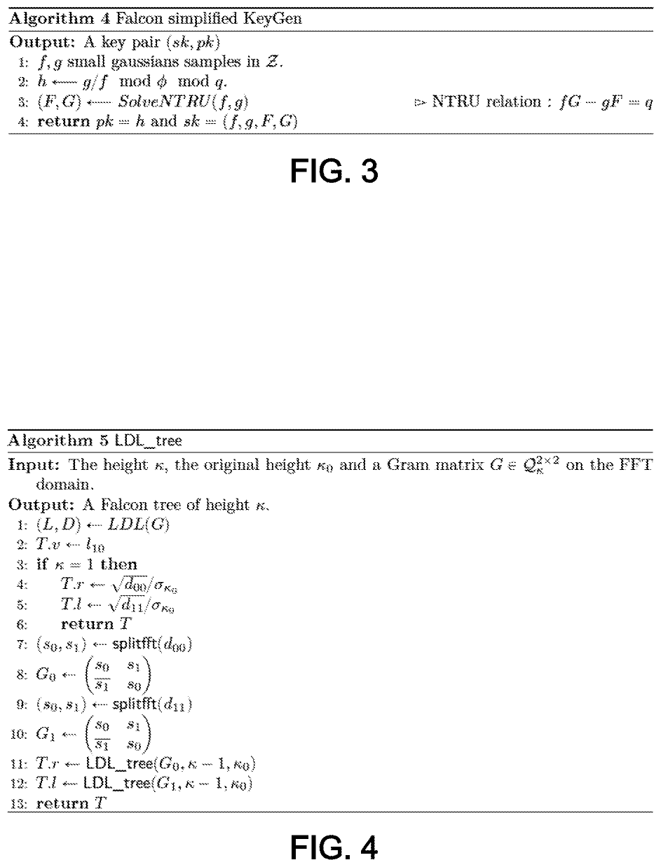

An exemplary simplified view of the Falcon Key Generation algorithm is illustrated by FIG. 3.

As explained in the Falcon specification, various algorithms may be considered for the Trapdoor sampler, as four propositions were present in the literature when Falcon was designed:

A first algorithm uses a randomized version of the nearest-plane algorithm, outputs a vector of norm proportional to the norm of Gram-Schmidt matrix of the basis, which is optimal, but runs in O(n²).

A second algorithm uses a randomized version of the round-off algorithm. It can use the tower of ring structure to run in O(n log n) but outputs larger vectors.

A third algorithm which is simple, efficient and outputs vectors of optimal norm may be used. However, such algorithm is designed for LWE, and therefore is not straightforwardly suited to NTRU lattices.

A fourth algorithm uses a randomized variant of the nearest-plane algorithm with a fast Fourier-like recursive design allowing to run in O(n log n). This algorithm is unfortunately not parallelizable.

The Falcon designers chose the fourth algorithm (Fast Fourier sampling, or FFS) for the Falcon trapdoor sampling, in order to combine high performances with the compactness of NTRU lattices.

A large part of the computation for a signature being independent of a given input message m, some of the data used in this computation may be precomputed and stored in memory. Specifically, some data may be stored on a precomputed so-called “expanded key” that comprises the basis on the FFT domain and a tree structure called a “Falcon tree”.

A Falcon tree T of height κ may be defined inductively, as follows:

A Falcon tree T of height 0 consists of a single node whose value is a real σ>0.

A Falcon tree T of height κ>0 has for root value T.v, a polynomial l∈Q_{κ} and its left and right children, noted T.l and T.r, are Falcon trees of height κ−1.

A Falcon tree may be computed inductively according to the algorithm illustrated by FIG. 4 (Algorithm 5 “LDL_tree”). At each height, a two-by-two Gram matrix is obtained, based on which a LDL decomposition can be computed. The non-trivial coefficient of

$$L = ( \begin{matrix}1 & 0 \\ \frac{\overline{{g}_{01}}}{{g}_{00}} & 1\end{matrix} ) ,$$

that is,

$${l}_{10} = \frac{\overline{{g}_{01}}}{{g}_{00}} ,$$

becomes the root (T.v) of the tree of height κ. Then, d₀₀ and d₁₁ are split inductively to compute, respectively, the right and the left children. Finally, the leaves of the tree are normalized with respect to a standard deviation depending on κ₀, that is, the original height of the tree.

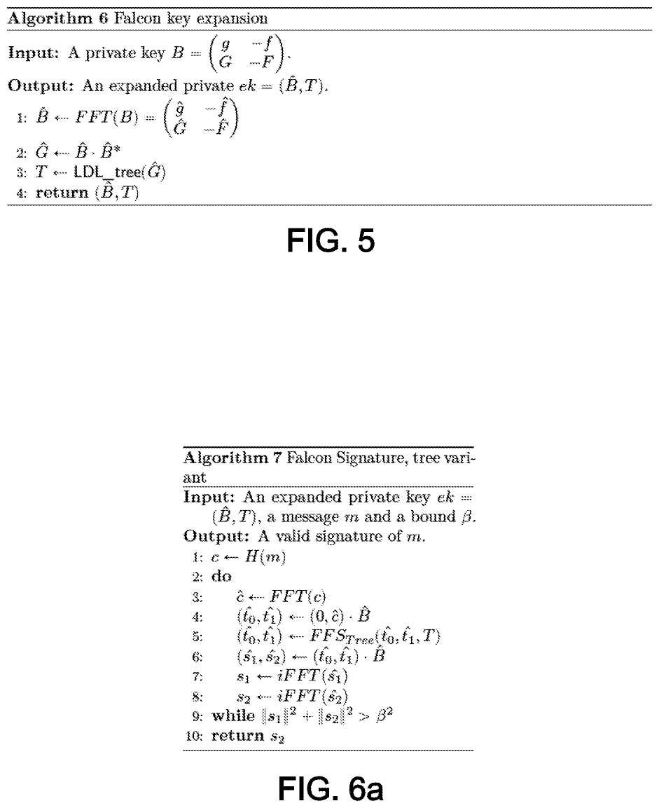

The computation of an expanded key may be performed according to the algorithm illustrated by FIG. 5 (Algorithm 6 “Falcon key expansion”).

While data of the Falcon tree is required for the signature of a message m, the computation of the tree may advantageously be performed dynamically, which allows to reduce the memory footprint since only the active branch and the coefficients of the Gram matrices need to be stored in memory. This leads to two possible message signature algorithm designs, as follows:

A first algorithm, referred herein to as the “Tree Signature” or “Tree Variant” algorithm, according to which the key is expanded with the basis on the FFT domain and the tree, and the expanded key is used to sign any number of messages.

A second algorithm, referred herein to as the “Dynamic Signature” or “Dynamic Variant” algorithm, according to which the LDL decompositions are computed on-the-fly with the flow of the signature. This algorithm requires to recompute the LDL decompositions for each signature.

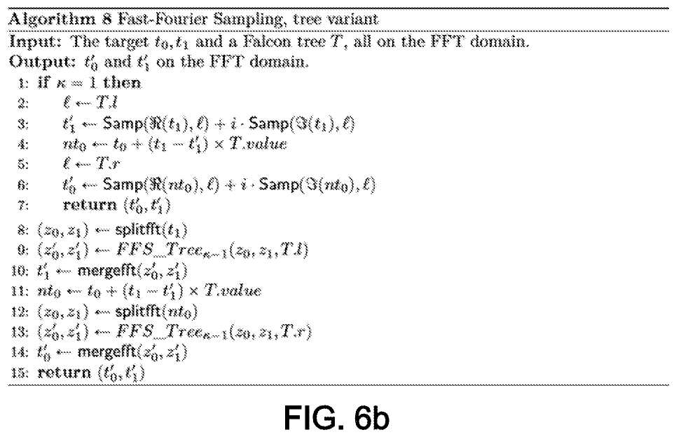

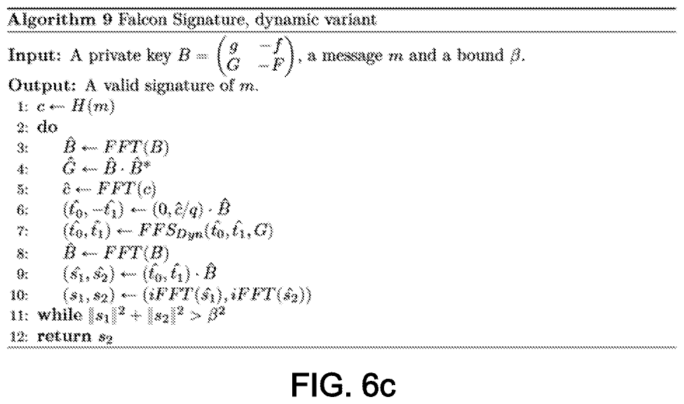

An exemplary implementation of the Tree Signature algorithm is provided in FIG. 6a (Algorithm 7—“Falcon Signature, Tree Variant”), and an exemplary implementation of the Dynamic Signature algorithm is provided in FIG. 6c (Algorithm 9—“Falcon Signature, Dynamic Variant”).

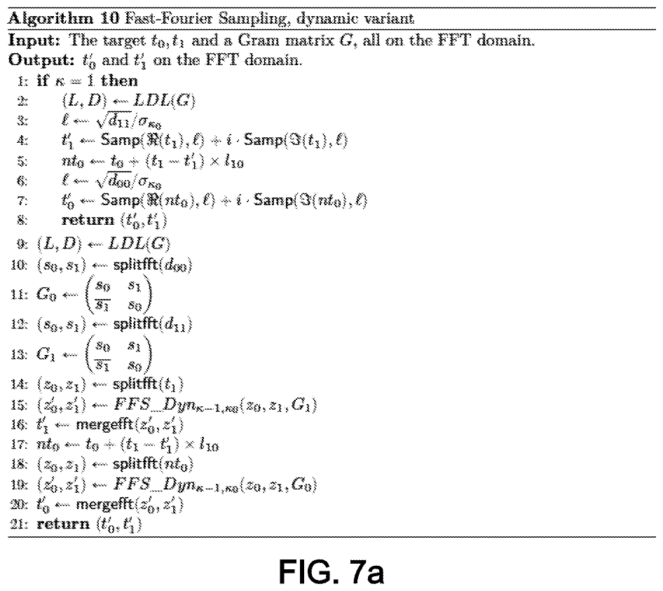

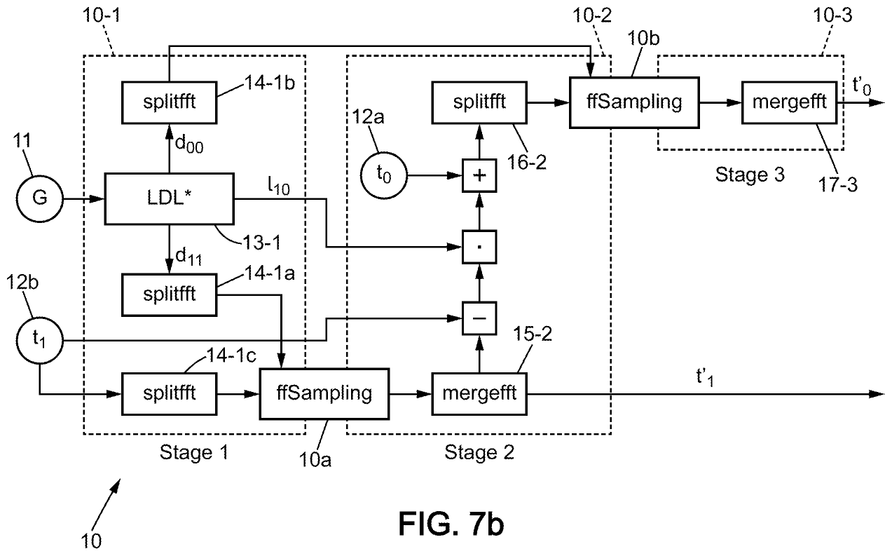

In addition, an exemplary implementation of a Dynamic Fast Fourier Sampling algorithm, used in the Dynamic Signature algorithm, is provided in FIG. 7a (Algorithm 10—“Fast-Fourier Sampling, dynamic variant”), and an exemplary implementation of a Tree Variant Fast Fourier Sampling algorithm, used in the Tree Variant Signature algorithm, is provided in FIG. 6b (Algorithm 8—“Fast-Fourier Sampling, tree variant”).

FIG. 7b discussed below provides a flowchart of an illustrative implementation of a Falcon dynamic fast Fourier sampling algorithm.

As shown on FIG. 6a for the Tree Variant, we simply remove the LDL computation and the l₁₀ polynomial is brought by the LDL tree.

In both variants, we rely on the routine Samp to provide us with integer Gaussian sampling. Further details on this process may be found in PFH20.

At the deepest level of the Fast Fourier Sampling (FFS), we have t₀, t₁∈ [symbol] , and we simply output t′ₓ=Samp(tₓ, T.v) for the tree variant and t′ₓ=Samp(tₓ, \sqrt{g₀₀}/σ_{κ}_{₀}) for the dynamic variant.

As mentioned above, in order to perform a Tree Variant signature, one first needs to expand the private key using a Key Expansion algorithm such as illustrated by FIG. 5 (Algorithm 6—“Falcon key expansion”).

In order to perform a Dynamic Variant signature such as illustrated by FIG. 6c (Algorithm 9—“Falcon Signature, Dynamic Variant”) in Algorithm 9, the FFT of the basis is recomputed in order to free memory space for the FFS.

The memory consumption for both variants of the FFS and the expanded key is rather large. This is mainly due to the polynomials on the FFT domain that are used to speed up the signature.

During the FFS in the Dynamic Variant, the coefficients of the Gram matrix can be split. As their merged form is not used thereafter, the original coefficients can be overwritten, and only the memory that was initially allocated will be needed.

In addition, a memory buffer is needed to perform the split operation. On the Falcon tree computation, the designers did not use this memory management strategy, and as a result their method uses twice as much memory.

For the Dynamic Variant, we need to store the l₁₀ polynomial until the computation of the new target between the two recursive calls. Thus, we need to be able to store a polynomial for each height, which represent n+n/2+n/4+ . . . +1=2n−1 double precision coefficients, which is (almost) equivalent to two degree n polynomials. For the target polynomials in both variants, we have a similar rational leading us to 2n double precision coefficients for each target, thus, four degree n polynomials.

In the Table 1 below, we summarize the memory requirement, in bytes, for the exemplary cases of security levels κ=9 (corresponding to 128 security bits) and κ=10 (corresponding to 256 security bits), for the general formulae, for the expanded key, and the temporary buffers for the Key Expansion algorithm, the Tree Signature algorithm, and the Dynamic Signature algorithm of Falcon. The numbers used in Table 1 below are those given by the reference implementation of Falcon that uses a few more bytes. Also, it does not consider the storage of the roots of unity:

TABLE 1
memory requirements in bytes for the Falcon signature algorithms

| Algorithm | Falcon general formula | κ = 9 | κ = 10 |
|---|---|---|---|
| Expanded key | 8 × (κ + 1 + 4) × 2^{κ} | 57352 | 122888 |
| Key Expansion | (4 × 1 + 6 × 8) × 2^{κ} | 26631 | 53255 |
| Signature | (1 × 2 + 6 × 8) × 2^{κ} | 25607 | 51207 |
| (tree variant) | | | |
| Signature | (1 × 2 + 4 × 1 + 9 × 8) × 2^{κ} | 39943 | 79879 |
| (dynamic | | | |
| variant) | | | |

The Falcon signature verification is straightforward, since the signature is only composed of s₂. In some embodiments, c and s₁ may be first recovered using h, and it may be checked that the vector (s₁, s₂) is indeed shorter than the bound β.

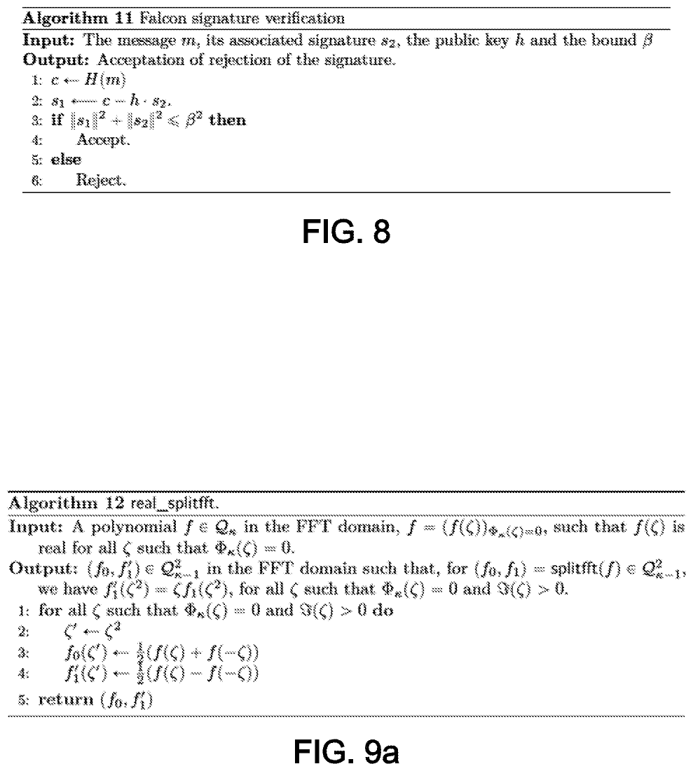

FIG. 8 shows an exemplary implementation of a Falcon signature verification algorithm.

FIG. 7b shows a block diagram illustrating the implementation (10) of the Falcon dynamic Fast Fourier Algorithm (FFS) that may be used in embodiments of the present subject disclosure. For example, the FFS algorithm illustrated by FIG. 7b may be used in the dynamic variant of the Falcon signature scheme, such as implemented by the exemplary algorithm illustrated by FIG. 6c (“FFS_{Dyn}” call in operation 7: “( [symbol] , [symbol] )←FFS_{Dyn}( [symbol] , [symbol] , G)”).

Such fast Fourier sampling scheme (10) may be implemented by a computer system, e.g. at a processing node of a computer system.

The Falcon dynamic fast Fourier sampling is a recursive algorithm that takes as input data a 2×2 Gram matrix G (11) whose coefficients are polynomials and a target vector (12a, 12b) t=[t₀, t₁], where tₒ and t₁ are polynomials, and produces as output data two polynomials t′₀ and t′₁. As shown on FIG. 7b, the FFS algorithm may be implemented with three stages (“Stage 1”, “Stage 2”, and “Stage 3”), each separated by a recursive call (“ffSampling” blocks 10a and 10b). In the FFS algorithm illustrated on FIG. 7b, the “splitfft” and “mergefft” functions may be implemented according to the algorithms described above, and illustrated on FIGS. 2a and 2b, respectively.

As shown on FIG. 7b, the following operations may be performed in the first stage (10_1): The LDL decomposition of the matrix G is computed (13_1), and produces diagonal coefficients d₀₀ and d₁₁ of the D matrix of the LDL decomposition, and the lower coefficient l₁₀ of the L matrix of the decomposition: G is decomposed into a matrix product as a unique matrix product L.D.L*, with L being a lower triangular matrix with ones on the diagonal, and D being a diagonal matrix.

$$For G = ( \begin{matrix}{g}_{00} & {g}_{01} \\ {g}_{10} & {g}_{11}\end{matrix} ) ,$$

$$we have D = ( \begin{matrix}{d}_{00} & 0 \\ 0 & {d}_{11}\end{matrix} ) = ( \begin{matrix}{g}_{00} & 0 \\ 0 & {g}_{11} - \frac{{\vert {g}_{01} \vert}^{2}}{{g}_{00}}\end{matrix} ) ,$$

$$and L = ( \begin{matrix}1 & 0 \\ {l}_{10} & 1\end{matrix} ) = ( \begin{matrix}1 & 0 \\ \frac{\overline{{g}_{01}}}{{g}_{00}} & 1\end{matrix} ) .$$

Then, respective splits (“splitfft” 14_1a and 14_1b) of the coefficients d₀₀ and d₁₁ of the D matrix are computed, and the results of these splits are used as Gram matrix data input to the two recursive calls between stages 1 and 2 (ffSampling call 10a), and between stages 2 and 3 (ffSampling call 10b), respectively.

In addition, in the first stage (10_1) the polynomial t₁ is split (“splitfft” 14_1c), and the result of this split is used as target vector data input to the recursive call between stages 1 and 2 (ffSampling call 10a).

As shown on FIG. 7b, the stage 2 (10_2) uses as input data the computed coefficient l₁₀, the result data of the split of d₀₀, and the input data t₀ and t₁.

The following operations may be performed in the second stage (10_1): The output of the recursive call (“ffSampling” 10a) may be merged (“mergefft” 15_2) to produce a polynomial t′₁ which will comprised in the output data of the FFS algorithm.

In addition, the operation (t₁−t′₁)·l₁₀+t₀ is performed, and the result of this operation is split (“splitfft” 16_2). The result of the split operation (14_1b) of d₀₀ in the first stage (10_1) is used as Gram matrix data input to the recursive call between stages 2 and 3 (ffSampling call 10b), and the result of this split operation (16_2) is used as target vector data input to this recursive call (ffSampling call 10b).

The following operations may be performed in the third stage (10_3): The output of the second recursive call (“ffSampling” 10b) may be merged (“mergefft” 17_3) to produce a polynomial t′₀ which will comprised in the output data of the FFS algorithm, together with the polynomial t′₁ output by the second stage (10_2).

As shown on FIG. 7b, the output of each recursive calls (“ffSampling” 10a and 10b) comprises two polynomials that are merged into one polynomial using a “mergefft” algorithm (15_2 and 17_3, respectively) such as the exemplary one illustrated by FIG. 2b.

At the deepest recursive call level of the FFS algorithm illustrated on FIG. 7b, that is, at the level where the input polynomials are real constants, two discrete Gaussian sampling respectively centered at t₀ and t₁, and with standard deviation σₘᵢₙ/\sqrt{g₀₀} (with σₘᵢₙ being a predetermined constant) are performed.

Therefore, as illustrated on FIG. 7b, the dynamic variant of the Falcon fast Fourier sampling algorithm may be implemented using recursive calls. In some embodiments, the present subject disclosure takes advantage of these recursive calls for providing an improved scheme for managing memory space required for implementing the algorithm.

In contrast, for the tree variant of the Falcon fast Fourier sampling, the needed coefficients that are computed from the Gram matrix G may be pre-computed in a Falcon tree as described above.

The memory consumption for both variants (tree variant and dynamic variant) of the Falcon signature is relatively high due to the double precision coefficients. However, the reference implementations given by the Falcon designers does not fully take advantage of the structure of a Gram matrix. While it might not appear as a problem on computers with large amount of RAM, most embedded devices have more restrained memory resources.

In order to address this constraint, the proposed scheme advantageously allows reducing the memory footprint of the Falcon signature algorithms. The scheme advantageously uses the structure of a Gram matrix, which is self-adjoint, to avoid computing and storing g₁₀, since it is equal to g̅₀̅₁̅. Depending on the embodiment, it is also possible to use one or more, or all of the properties of self-adjoint matrices, to advantageously avoid superfluous computation and reduce memory usage, which results in a reduction of memory requirements for implementing the Falcon signature algorithms.

Depending on the embodiment, two aspects can be leveraged to optimize the implementation of a signature scheme such as Falcon by reducing the memory footprint of the implementation:

In some embodiments, the proposed scheme advantageously leverages the aspect according to which the diagonal coefficients of a Gram matrix are real numbers.

In some embodiments, the proposed scheme advantageously leverages the aspect according to which except for the top-level call of recursive implementations of Falcon functions, the Gram matrices are quasi-cyclic.

In one or more embodiments, the proposed scheme advantageously uses the structure of a Gram matrix (as used to implement the Falcon signature scheme) to improve the management of the memory of the computer on which Falcon is implemented by reducing the memory footprint of the Falcon signature scheme.

As the diagonal coefficients g₀₀ and g₁₁ of the Gram matrix G (which is used as signature generation matrix in the Falcon signature scheme) are real numbers (and not complex numbers), the present subject disclosure provides that there is no need to store an imaginary part of these diagonal coefficients, nor to consider them as general complex number.

As a consequence, in one or more embodiments, during the computation of the LDL decomposition of the signature generation matrix G, the l₁₀ coefficient of the L matrix of the LDL decomposition may be computed as l₁₀=g̅₀̅₁̅/g₀₀ as described above, however since g₀₀ is a real number, there is no need to implement this division as a general complex division. In other words, since g₀₀ is real, it is sufficient to compute its inverse 1/g₀₀, and to perform a real-complex multiplication with g̅₀̅₁̅. Using a real inverse computation followed by a real-complex multiplication advantageously reduces the computation complexity of the LDL decomposition, and also improves precision. This improvement allows reducing the size of the memory buffer used for implementing the LDL decomposition algorithm (used for the dynamic variant of the FFS algorithm as illustrated by FIG. 7b and/or used for the key expansion algorithm as illustrated by FIG. 5) by one degree n polynomial.

In one or more embodiments, the proposed scheme advantageously uses the specific form of the Gram matrix (as used to implement the dynamic FFS algorithm illustrated on FIG. 7b and the LDL_tree algorithm illustrated on FIG. 4) to improve the management of the memory of the computer on which Falcon is implemented by reducing the memory footprint of the Falcon signature scheme. As shown on FIG. 4 for the LDL_tree algorithm, and on FIG. 7b for the dynamic FFS algorithm, the LDL_tree and dynamic FFS algorithms use recursive calls, each of which uses a Gram matrix as input data.

Specifically, as shown on FIG. 4, the LDL_tree algorithm operating on a height κ, an original height κ₀, and a Gram matrix G as input data, includes two recursive calls (operation 11: “T.r←LDL_tree(G₀, κ−1, κ₀)” and operation 12: “T.r←LDL_tree(G₁, κ−1, κ₀)”). As shown on FIG. 7b, the ffSampling algorithm (10) includes two recursive calls (10a) and (10b). For each of these two algorithms, the first call (which may be referred to herein as the “top height”) will trigger at least one trigger recursive call, which will correspond to an execution of the algorithm at a lower height, and each call at a given height will trigger an execution of the algorithm at a lower height.

The Gram matrix used as input data of the top height of the dynamic FFS algorithm and the LDL tree algorithm does not have any specific form. Indeed, as shown on line 4 of the Falcon Signature algorithm (dynamic variant) illustrated by FIG. 6c (Algorithm 9), the first signature generation matrix G used for the initial call of the FFS_{Dyn} function is obtained in the frequency domain based on the key B: “Ĝ←\hat{B}·\hat{B}*”. In some embodiments, the G matrix may be a 2×2 Gram matrix, therefore of the form

$$G = ( \begin{matrix}{g}_{00} & {g}_{01} \\ \overline{{g}_{01}} & {g}_{11}\end{matrix} ) ,$$

where g̅₀̅₁̅ designates the complex conjugate of g₀₁, the storage of which requiring the memory space for storing g₀₀, g₀₁, and g₁₁.

However, in one or more embodiments, for lower heights, the Gram matrix used in recursive calls of the dynamic FFS algorithm or the LDL_tree algorithm is of the following form:

$$G = ( \begin{matrix}{g}_{00} & {g}_{01} \\ \overline{{g}_{01}} & {g}_{00}\end{matrix} )$$

(referred to herein as “quasi-cyclic” form), where goi designates the complex conjugate of g₀₁, the storage of which requiring only the memory space for storing g₀₀ and g₀₁ (instead of requiring the memory space for storing g₀₀, g₀₁, and g₁₁)

Referring to the dynamic FFS algorithm illustrated by FIG. 7b, this is due to the fact that, besides the input matrix G (11) which is generated based on the key B, the other G matrices that are used as input of the recursive calls “ffSampling” (10a) and (10b) are the results of the splitfft call (14_1a, 14_1b) applied to the coefficients d₁₁ and d₀₀, respectively.

Likewise, for the LDL_tree algorithm of Falcon (such as illustrated on FIG. 4), the Gram matrix used as input data of the top height of the algorithm is the Gram matrix G used as input to the algorithm. As shown on lines 8 and 10 of the Falcon LDL_tree algorithm illustrated by FIG. 4, the Gram matrix G0 and G1 used respectively in the recursive calls of lines 11 and 12 are both of the form

$$( \begin{matrix}{s}_{0} & {s}_{1} \\ \overline{{s}_{1}} & {s}_{0}\end{matrix} ) ,$$

where s̅₁̅ designates the complex conjugate of s₁, the storage of which requiring only the memory space for storing s₀ and s₁.

Therefore, after determining the first LDL representation, there is no longer a need to store in a memory buffer the matrix coefficient g₁₁, as the storing in memory of a matrix of the form

$$( \begin{matrix}{g}_{00} & {g}_{01} \\ \overline{{g}_{01}} & {g}_{00}\end{matrix} )$$

only requires memory space for storing the matrix coefficients g₀₀ and g₀₁. In one or more embodiments, the very first coefficient may be stored in an empty buffer, that is, a memory buffer that is not specifically dedicated to the storing of the matrix coefficient g₁₁, which advantageously reduces the size of the memory buffer used for executing the dynamic signature algorithm and the key expansion algorithm by a n/2 degree polynomial.

As shown in FIG. 7b for the “fast Fourier sampling” algorithm (for the dynamic variant of the signature algorithm), the “splitfft” function may, in some embodiments, be applied to the polynomials d₀₀ and d₁₁, which are real polynomials.

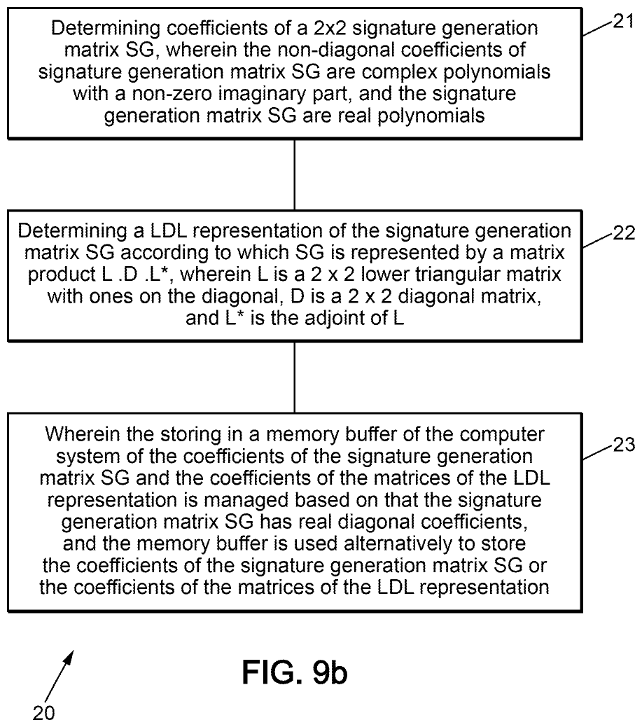

For this purpose, in order to reduce computational cost and associated use of memory resource, a new “splitfft” function which operates a split of a real polynomial in the frequency domain, referred to herein as “real_splitfft”, is proposed in the present subject disclosure. An exemplary implementation of the proposed “real_splitfft” function is shown in the algorithm of FIG. 9a (“Algorithm 12 real_splitfft”).

Implementing this proposed split function advantageously provides a memory usage optimization as the output of the “real_splitfft” are real polynomials, and reduces the butterfly cost. Specifically, the computational cost of the Falcon “splitfft” algorithm includes that of two complex additions (including a complex subtraction which corresponds to the same cost) and one complex multiplication per coefficient, which corresponds to six real additions and four real multiplications per coefficient. In comparison, the computational cost of the exemplary implementation of the proposed “real_splitfft” function merely includes that of 2 real additions per coefficient.

As shown on FIG. 9a, in some embodiments, the proposed “real_splitfft” algorithm splits an input real polynomial f into two real polynomials f₀ and f₁. The two output polynomials may be denoted f₀ and f′₁, and may be defined by their coordinates in the frequency domain. The proposed algorithm may use a loop over half of the coordinates of the input f, indexed by the root of unity ζ in the frequency domain (as the other half may be indexed by the opposite of the root of unity −ζ). In each iteration of the loop, the index for f₀ and f′₁, denoted ζ′, is first computed. Then the values f₀(ζ′) and f′₁(ζ′) are respectively computed as follows:

$${f}_{0} ( {ζ}^{′} ) ← \frac{1}{2} ( f ( ζ ) + f ( - ζ ) ) , and {f}_{1}^{′} ( {ζ}^{′} ) ← \frac{1}{2} ( f ( ζ ) - f ( - ζ ) ) .$$

As compared with the Falcon “splitfft” algorithm illustrated by FIG. 2a which requires a complex operation for computing

$${f}_{1} ( {ζ}^{′} ) ( {f}_{1} ( {ζ}^{′} ) ← \frac{1}{2 ζ} ( f ( ζ ) - f ( - ζ ) ) ) ,$$

the computation of f′₁(ζ′) according to the proposed “real_splitfft” algorithm avoids such complex operation.

Therefore, referring to FIG. 7b, in some embodiments, the “splitfft” operations (14-1a and 14-1b) respectively used for splitting the polynomials d₀₀ and d₁₁ may, for each call of the “ffSampling” function (including recursive calls), advantageously be implemented using the proposed “real_splitfft” algorithm, instead of the “splitfft” specified by Falcon, as the polynomials d₀₀ and d₁₁ are real polynomials.

In addition, as the root of unity (e.g. the root of unity ζ used in the Falcon splitfft algorithm, such as illustrated by FIG. 2a) is a constant, the multiplication with the root of unity can be delayed in the computations. Therefore, the real output is denoted g′₀₁, and the root of unity multiplication used in the Falcon splitfft algorithm, such as illustrated by FIG. 2a (e.g. on line 4, as dividing by the root of unity ζ may be performed using a complex multiplication by a complex conjugate of the root of unity ζ) may be performed only once the coefficient g₀₁ is actually needed. In particular, in some embodiments of the Falcon specifications, the coefficient g₀₁ may only be needed for the LDL representation computation.

The LDL decomposition involves the computation of a D matrix, and a L matrix, based on a G matrix, with:

$$G = ( \begin{matrix}{g}_{00} & {g}_{01} \\ \overline{{g}_{01}} & {g}_{11}\end{matrix} ) ,$$

and results in:

$$D = ( \begin{matrix}{g}_{00} & 0 \\ 0 & {g}_{11} - \frac{\vert {g}_{01} {\vert}^{2}}{{g}_{00}}\end{matrix} )$$

$$and$$

$$L = ( \begin{matrix}\frac{\frac{1}{{g}_{01}}}{{g}_{00}} & 0 \\ & 1\end{matrix} ) .$$

If one sets g₀₁=s·g′₀₁, where g′₀₁ is the output of the “real_splitfft” function provided by the present subject disclosure, and s is the root of unity that was delayed, it follows that:

$${d}_{11} = {g}_{11} - \frac{\overline{{g}_{01}} , {g}_{01}}{{g}_{00}} = {g}_{11} - \frac{\overline{s \cdot {g}_{01}^{′}} \cdot s \cdot {g}_{01}^{′}}{{g}_{00}} = {g}_{11} - \overline{s} \cdot s \frac{{{g}_{01}^{′}}^{2}}{{g}_{00}} = {g}_{11} - \frac{{{g}_{01}^{′}}^{2}}{{g}_{00}} .$$

In view of the above computation, as s̅·s=1 (as s is a root of unity), in some embodiments, there is no need to multiply by the root of unity for d₁₁, and a complex multiplication is replaced with a real multiplication, thereby improving computation complexity performances as well as precision of the computation.

In addition,

$${l}_{10} = \frac{\overline{{g}_{01}}}{{g}_{00}} = \frac{\overline{s} \cdot {g}_{01}^{′}}{{g}_{00}} .$$

Therefore, if we denote

$${l}_{10}^{′} = \frac{{g}_{01}^{′}}{{g}_{00}} ,$$

in some embodiments the computation of the real-complex multiplication by s may be delayed, and l′₁₀ can be stored in memory.

In addition, in computations with κ=1, s=\sqrt{2}/2+i\sqrt{2}/2, so that the number of multiplications may advantageously be reduced.

As discussed above, for the implementation of the dynamic FFS algorithm, the proposed scheme advantageously allows reducing the memory usage by a half polynomial because the top l₁₀ does not ensue from a quasi-cyclic Gram matrix.

For the tree variant signature algorithm, the memory usage reduction benefit provided by the proposed scheme comes from the expanded key algorithm where we can cut off κ−1 half polynomials from the κ+1 whole polynomial of the tree. In the tree FFS, there might be a small computational overhead since the multiplication by s may be delayed from the LDL tree computation to the FFS.

Table 2 below provides a comparison of the theoretical memory requirement in bytes for the signature related algorithms between the original Falcon design and the proposed scheme:

TABLE 2
comparison of memory requirements in bytes between
the original Falcon design and the proposed scheme

| | Falcon general formula | |
|---|---|---|
| Algorithm | Original Falcon design | Proposed scheme |
| Expanded key | 8 × (κ + 1 + 4) × 2^{κ} bytes | 8 × ((κ + 1)/2 + 1 + 4) × |
| | | 2^{κ} bytes |
| Key Expansion | (4 × 1 + 6 × 8) × 2^{κ} bytes | (4 × 1 + 3 × 8) × 2^{κ} bytes |
| Signature | (1 × 2 + 6 × 8) × 2^{κ} bytes | (1 × 2 + 4 × 8) × 2^{κ} bytes |
| (tree variant) | | |
| Signature | (1 × 2 + 4 × 1 + 9 × 8) × | (1 × 2 + 4 × 1 + 6.5 × 8) × |
| (dynamic | 2^{κ} bytes | 2^{κ} bytes |
| variant) | | |

Table 3 below presents the reduced memory consumption provided by the proposed scheme, and shows that, depending on the embodiment, the proposed scheme may provide a benefit of 25% to 46%.

In some embodiments, the key expansion could be performed without any additional buffers by storing the temporary variables in the LDL tree.

TABLE 3
comparison of memory requirements in bytes between
the original Falcon design and the proposed scheme

| | κ = 9 | | | κ = 10 | | |
|---|---|---|---|---|---|---|
| | Original | | | Original | | |
| | Falcon | Proposed | | Falcon | Proposed | |
| Algorithm | design | scheme | Gain | design | scheme | Gain |
| Signature | 39943 | 29703 | 31% | 79879 | 59399 | 31% |
| (dynamic | bytes | bytes | | bytes | bytes | |
| variant) | | | | | | |
| Key | 26631 | 14343 | 46% | 53255 | 28679 | 46% |
| Expansion | bytes | bytes | | bytes | bytes | |
| Expanded | 57352 | 40968 | 29% | 122888 | 86024 | 30% |
| key | bytes | bytes | | bytes | bytes | |
| Signature | 25607 | 17415 | 32% | 51207 | 34823 | 32% |
| (tree variant) | bytes | bytes | | bytes | bytes | |

FIG. 9b shows a flow chart diagram illustrating the memory management (20) in a computer system configured for generating a signature of a binary data message m using a key B of a predetermined lattice-based structure according to embodiments of the present subject disclosure.

As described with reference to FIG. 9b, in one or more embodiments, coefficients of a 2×2 signature generation matrix SG may be first determined (21), where the non-diagonal coefficients of signature generation matrix SG are complex polynomials with a non-zero imaginary part, and the diagonal coefficients of the signature generation matrix SG are real polynomials.

In some embodiments, the 2×2 signature generation matrix SG may be of the form

$$S G = ( \begin{matrix}{g}_{00} & {g}_{01} \\ {g}_{10} & {g}_{11}\end{matrix} ) ,$$

with g₀₀ and g₁₁ being real polynomials, and g₀₁ and g₁₀ being complex polynomials with a non-zero imaginary part.

In one or more embodiments, further to determining the coefficients of the 2×2 signature generation matrix SG, a LDL representation of the signature generation matrix SG is determined (22), according to which SG is represented by a matrix product L.D.L*, wherein L is a 2×2 lower triangular matrix with ones on the diagonal, D is a 2×2 diagonal matrix, and L * is the adjoint of L.

In some embodiments, the L matrix may be of the form

$$L = ( \begin{matrix}1 & 0 \\ {l}_{10} & 1\end{matrix} ) ,$$

and the coefficient l₁₀ of the matrix L may be determined as

$${l}_{10} = \frac{\overline{{g}_{01}}}{{g}_{00}} ,$$

wherein the signature generation matrix SG is of the form

$$( \begin{matrix}{g}_{00} & {g}_{01} \\ {g}_{10} & {g}_{11}\end{matrix} ) ,$$

where g₀₀ and g₁₁ are real polynomials, and g₁₀ and g₀₁ are complex polynomials. In some embodiments, the computing the coefficient l₁₀ of the matrix L may comprise the computing of the inverse 1/g₀₀ of the real polynomial coefficient g₀₀, and performing a real-complex multiplication of 1/g₀₀ with the complex polynomial g̅₀̅₁̅.

In some embodiments, the D matrix may be of the form

$$D = ( \begin{matrix}{d}_{00} & 0 \\ 0 & {d}_{11}\end{matrix} ) ,$$

and may be determined as:

$$( \begin{matrix}{g}_{00} & 0 \\ 0 & {g}_{11} - \frac{\vert {g}_{01} {\vert}^{2}}{{g}_{00}}\end{matrix} ) ,$$

wherein the signature generation matrix SG is of the form

$$( \begin{matrix}{g}_{00} & {g}_{01} \\ {g}_{10} & {g}_{11}\end{matrix} ) ,$$

where g₀₀ and g₁₁ are real polynomials, and g₁₀ and g₀₁ are complex polynomials.

In one or more embodiments, the storing in a memory buffer of the computer system of the coefficients of the signature generation matrix SG and the coefficients of the matrices of the LDL representation based on that (a) the signature generation matrix SG has real diagonal coefficients, and/or (b) the memory buffer is used alternatively to store the coefficients of the signature generation matrix SG or the coefficients of the matrix D of the LDL representation. As a consequence, advantageously, memory usage is reduced (and therefore the memory space required for using the proposed scheme for implementing a signature algorithm according to the present subject disclosure), part or all of the same memory space that is used to store the signature generation matrix SG may be reused for storing the matrix D of the LDL representation.

As discussed above, the proposed memory management scheme may advantageously be used when implementing a signature generation algorithm, such as according to the Falcon signature scheme, for reducing the memory footprint of the implementation without any significant degradation of performances. The resulting memory footprint reduction may advantageously be used when implementing a signature generation algorithm on computer systems with limited memory resources, such as, for example, embedded implementations of the software generation algorithm.

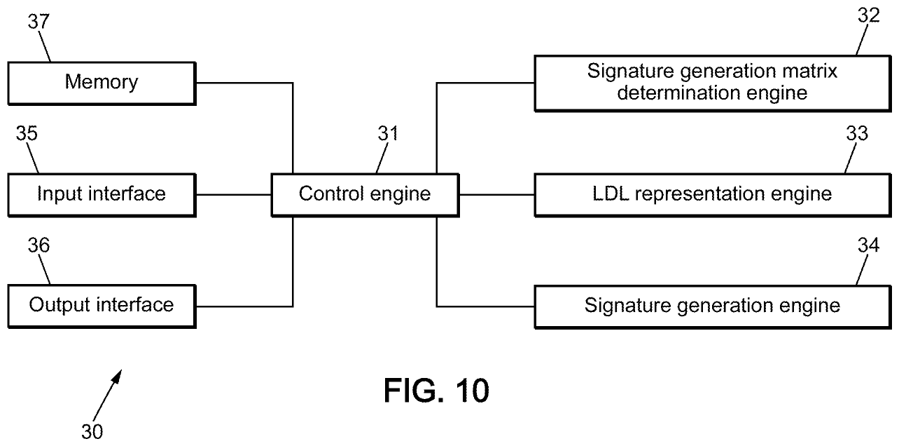

An exemplary architecture of a non-quantum computer apparatus according to the present subject disclosure is illustrated on FIG. 10, which shows a computer apparatus (30) configured to perform a memory management method in accordance with embodiments of the present subject disclosure.

The computer apparatus 30 includes a control engine 31, a signature generation matrix determination engine 32, a LDL representation determination engine 33, a signature generation engine 34, an input interface 35, an output interface 36, and a memory 37.

In the architecture illustrated on FIG. 10, all of the signature generation matrix determination engine 32, LDL representation determination engine 33, signature generation engine 34, input interface 35, output interface 36, and memory 37 are operatively coupled with one another through the control engine 31.

In some embodiments, the input interface 35 is configured for receiving data representing a binary data message m, and data representing a key B that was generated, and transmitting received data to the control engine 31 for further processing according to embodiments of the present subject disclosure.

In some embodiments, the output interface 36 is configured for outputting data representing a signed message corresponding to the input binary data message m signed using the key B, or a signature generated based on a binary data message m using the key B, and transmitting such data to an external host or to another engine of the computer apparatus 30.

In some embodiments, the signature generation matrix determination engine 32 may be configured to process received data for determining, based on the key B, coefficients of a 2×2 signature generation matrix SG, where the non-diagonal coefficients of the signature generation matrix SG are complex polynomials with a non-zero imaginary part, and the diagonal coefficients of the signature generation matrix SG are real polynomials.

In some embodiments, the LDL representation engine 33 may be configured to process the signature generation matrix SG determined by the signature generation matrix determination engine 32. In particular, in one or more embodiments, the LDL representation engine 33 is configured to determine a LDL representation of the signature generation matrix SG (determined by the signature generation matrix determination engine 32). The LDL representation is such that SG is represented by a matrix product L.D.L*, wherein L is a 2×2 lower triangular matrix with ones on the diagonal, D is a 2×2 diagonal matrix, and L* is the adjoint of L.

In some embodiments, the signature generation engine 34 may be configured to implement signature algorithms according to a signature scheme, such as the Falcon signature scheme, used by the computer apparatus 30 for signing the message m.

In some embodiments, the computer apparatus 30 does not include a memory management engine, and one or more embodiments of the memory management scheme provided in the present subject disclosure are implemented in the software programming of the engines of the computer apparatus 30, such as the signature generation matrix determination engine 32, the LDL representation engine 33, and the signature generation engine 34.

The control engine 31 includes a processor, which may be any suitable microprocessor, microcontroller, Field Programmable Gate Arrays (FPGA), Application Specific Integrated Circuits (ASIC), Digital Signal Processing chip, and/or state machine, or a combination thereof. According to various embodiments, one or more of the computers can be configured as a multi-processor computer having multiple processors for providing parallel computing. The control engine 31 may also comprise, or may be in communication with, computer storage media, such as, without limitation, the memory 37, capable of storing computer program instructions or software code that, when executed by the processor, cause the processor to perform the elements described herein. In addition, the memory 37 may be any type of data storage or computer storage medium coupled to the control engine 31 and operable with the interfaces 35-36 to facilitate management of data stored in association therewith, such as, for example, a cache memory, a RAM memory, a ROM memory, a FPGA memory, a datacenter, a data cloud, or a combination thereof.

In some embodiments, the memory 37 may comprise a memory buffer dimensioned for storing the coefficients of the signature generation matrix SG and the coefficients of the matrices of the LDL representation based on that (a) the signature generation matrix SG has real diagonal coefficients, and/or (b) the memory buffer is used alternatively to store the coefficients of the signature generation matrix SG or the coefficients of the matrix D of the LDL representation. In some embodiments, the size of the memory buffer may be reduced to that needed for managing the memory buffer according to the present disclosure. For example, in some embodiments, the size of the memory buffer may be reduced to that needed for storing the coefficients of the signature generation matrix SG and the coefficients of the matrices of the LDL representation based on that (a) the signature generation matrix SG has real diagonal coefficients, and/or (b) the memory buffer is used alternatively to store the coefficients of the signature generation matrix SG or the coefficients of the matrix D of the LDL representation.

In addition, the memory 37 may be configured to store the polynomials to and ti which are generated when implementing the dynamic variant of the Fast Fourier Sampling algorithm of the Falcon scheme, which polynomials depend on the input message m to be signed, and the signature key B.

It will be appreciated that the computer apparatus 30 shown and described with reference to FIG. 10 is provided by way of example only. Numerous other architectures, operating environments, and configurations are possible. Other embodiments of the node may include fewer or greater number of components, and may incorporate some or all of the functionality described with respect to the processing node components shown in FIG. 10. Accordingly, although the control engine 31, signature generation matrix determination engine 32, LDL representation engine 33, signature generation engine 34, input interface 35, output interface 36, and memory 37 are illustrated as part of the system 30, no restrictions are placed on the location and control of components 30-37. In particular, in other embodiments, components 30-37 may be part of different entities or computing systems.

In particular, the computer apparatus 30 may be embedded computer system, an electronic component (e.g. a FPGA device), or any other device comprising a processor operatively coupled with a memory.

The computer apparatus 30, and more generally any device configured for implementing embodiments of the present subject disclosure, may be implemented in software, in hardware, such as for example in an ASIC component, or in a combination of software and hardware, such as for example as a computer program designed to be loaded and executed on a FPGA device.

While the present subject disclosure has been described with respect to preferred embodiments, those skilled in the art will readily appreciate that various changes and/or modifications can be made to the present subject disclosure without departing from the scope of the present subject disclosure as defined by the appended claims.

Although this subject disclosure has been disclosed in the context of certain preferred embodiments, it should be understood that certain advantages, features and aspects of the systems, devices, and methods may be realized in a variety of other embodiments. Additionally, it is contemplated that various aspects and features described herein can be practiced separately, combined together, or substituted for one another, and that a variety of combination and sub-combinations of the features and aspects can be made and still fall within the scope of the subject disclosure. Furthermore, the systems and devices described above need not include all of the modules and functions described in the preferred embodiments.

Information and signals described herein can be represented using any of a variety of different technologies and techniques. For example, data, instructions, commands, information, signals, bits, symbols, and chips can be represented by voltages, currents, electromagnetic waves, magnetic fields or particles, optical fields or particles, or any combination thereof.

Depending on the embodiment, certain acts, events, or functions of any of the methods described herein can be performed in a different sequence, may be added, merged, or left out all together (e.g., not all described acts or events are necessary for the practice of the method). Moreover, in certain embodiments, acts or events may be performed concurrently rather than sequentially.

1. A computer-implemented method for memory management in a computer system configured for generating a signature of a binary data message m using a key B of a predetermined lattice-based structure, the method comprising:
determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials;
determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and
managing the storing in a memory buffer of the computer system of the coefficients of the signature generation matrix SG and the coefficients of the matrices of the LDL representation based on at least one of: (a) the signature generation matrix SG has real diagonal coefficients, and (b) the memory buffer is used alternatively to store the coefficients of the signature generation matrix SG or the coefficients of the matrix D of the LDL representation.

2. The method according to claim 1, wherein the memory buffer is dimensioned for storing complex non-diagonal coefficients and real diagonal coefficients of the signature generation matrix SG.

3. The method according to claim 1, wherein the diagonal matrix D is of the form
$$( \begin{matrix}{d}_{00} & 0 \\ 0 & {d}_{11}\end{matrix} )$$
and is determined as:
$$( \begin{matrix}{g}_{00} & 0 \\ 0 & {g}_{11} - \frac{\vert {g}_{01} {\vert}^{2}}{{g}_{00}}\end{matrix} ) ,$$
wherein the signature generation matrix SG is of the form
$$( \begin{matrix}{g}_{00} & {g}_{01} \\ {g}_{10} & {g}_{11}\end{matrix} ) ,$$
where g₀₀ and g₁₁ are real polynomials, and g₁₀ and g₀₁ are complex polynomials.

4. The method according to claim 1, wherein the key B has a matrix structure, and the signature generation matrix is determined based on the matrix product B.B*, wherein B* is the adjoint matrix of B.

5. The method according to claim 1, wherein the key B has a matrix structure, and the signature generation matrix is determined based on the matrix product \hat{B}.\hat{B}*, wherein \hat{B}* is the adjoint matrix of \hat{B}, and wherein \hat{B} is obtained based on a transform of the matrix B in a frequency domain.

6. The method according to claim 1, wherein the matrix L is of the form
$$( \begin{matrix}1 & 0 \\ {l}_{10} & 1\end{matrix} ) ,$$
the method further comprising: computing the coefficient l₁₀ of the matrix L as
$${l}_{10} = \overline{\frac{{g}_{01}}{{g}_{00}}} ,$$
wherein the signature generation matrix SG is of the form
$$( \begin{matrix}{g}_{00} & {g}_{01} \\ {g}_{10} & {g}_{11}\end{matrix} ) ,$$
where g₀₀ and g₁₁ are real polynomials, and g₁₀ and g₀₁ are complex polynomials, and wherein the computing the coefficient l₁₀ of the matrix L comprises: computing the inverse 1/g₀₀ of the real coefficient g₀₀, and performing a real-complex multiplication of 1/g₀₀ with the complex polynomial g̅₀̅₁̅.

7. The method according to claim 1, wherein the signature generation matrix SG is of the form:
$$( \frac{{g}_{00}}{{g}_{01}} \begin{matrix}{g}_{01} \\ {g}_{00}\end{matrix} ) ,$$
wherein g₀₀ is a real polynomial, g₀₁ is a complex polynomial, and g̅₀̅₁̅ is the complex conjugate of g₀₁, and wherein the memory buffer is dimensioned for storing g₀₀ and the real and imaginary parts of g₀₁.

8. The method according to claim 1, wherein the signature generation matrix is a Gram matrix of size 2×2.

9. The method according to claim 1, wherein the signature generation matrix SG is of the form
$$( \begin{matrix}{g}_{00} & {g}_{01} \\ {g}_{10} & {g}_{11}\end{matrix} ) ,$$
where g₀₀ and g₁₁ are real polynomials, and g₁₀ and g₀₁ are complex polynomials, wherein g₁₀ is equal to the complex conjugate g̅₁̅₀̅ of g₀₁, wherein the memory buffer is dimensioned to store real polynomials corresponding to g₀₀, g₁₁, and the real and imaginary parts of g₀₁, and wherein the diagonal matrix D is of the form
$$( \begin{matrix}{d}_{00} & 0 \\ 0 & {d}_{11}\end{matrix} )$$
and is determined as:
$$( \begin{matrix}{g}_{00} & 0 \\ 0 & {g}_{11} - \frac{{\vert {g}_{01} \vert}^{2}}{{g}_{00}}\end{matrix} ) ,$$
and the coefficient d₁₁ is stored in the memory buffer by overwriting one or more coefficients of the signature generation matrix SG.

10. The method according to claim 1, further comprising: generating a signature s₂ of the message m based on the determination of the coefficients of the signature generation matrix SG, and the determination of the LDL representation of the signature generation matrix SG.

11. The method according to claim 1, wherein the key B is of the form
$$( \begin{matrix}g & - f \\ G & - F\end{matrix} ) ,$$
wherein f, g, F, and G are polynomials of [symbol] [x]/(Φ_{κ}), where Φ_{κ}=xⁿ+1∈ [symbol] [x] for n=2^{κ}, and κ be a positive integer which verify the equation f·G−g·F=q mod(Φ_{κ}), where q is a constant equal to 12×2¹⁰+1.

12. An apparatus, the apparatus comprising a processor and a memory operatively coupled to the processor, wherein the apparatus is configured to perform a method for memory management in a computer system configured for generating a signature of a binary data message m using a key B of a predetermined lattice-based structure, the method comprising:
determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials;
determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and
managing the storing in a memory buffer of the computer system of the coefficients of the signature generation matrix SG and the coefficients of the matrices of the LDL representation based on at least one of: (a) the signature generation matrix SG has real diagonal coefficients, and (b) the memory buffer is used alternatively to store the coefficients of the signature generation matrix SG or the coefficients of the matrix D of the LDL representation.

13. A non-transitory computer-readable medium encoded with executable instructions which, when executed, causes an apparatus comprising a processor operatively coupled with a memory, to perform a method for memory management in a computer system configured for generating a signature of a binary data message m using a key B of a predetermined lattice-based structure, the method comprising:
determining, based on the key B, the coefficients of a 2×2 signature generation matrix SG, wherein the non-diagonal coefficients of the signature generation matrix SG are complex polynomials with a non-zero imaginary part, and the diagonal coefficients of the signature generation matrix SG are real polynomials;
determining a LDL representation of the signature generation matrix SG according to which SG is represented by a matrix product L.D.L*, wherein L is a 2×2 lower triangular matrix with ones on the diagonal, D is a 2×2 diagonal matrix, and L* is the adjoint of L; and
managing the storing in a memory buffer of the computer system of the coefficients of the signature generation matrix SG and the coefficients of the matrices of the LDL representation based on at least one of: (a) the signature generation matrix SG has real diagonal coefficients, and (b) the memory buffer is used alternatively to store the coefficients of the signature generation matrix SG or the coefficients of the matrix D of the LDL representation.

14. The apparatus according to claim 12, wherein the memory buffer is dimensioned for storing complex non-diagonal coefficients and real diagonal coefficients of the signature generation matrix SG.

15. The apparatus according to claim 12, wherein the diagonal matrix D is of the form
$$( \begin{matrix}{d}_{00} & 0 \\ 0 & {d}_{11}\end{matrix} )$$
and is determined as:
$$( \begin{matrix}{g}_{00} & 0 \\ 0 & {g}_{11} - \frac{{\vert {g}_{01} \vert}^{2}}{{g}_{00}}\end{matrix} ) ,$$
wherein the signature generation matrix SG is of the form
$$( \begin{matrix}{g}_{00} & {g}_{01} \\ {g}_{10} & {g}_{11}\end{matrix} ) ,$$
where g₀₀ and g₁₁ are real polynomials, and g₁₀ and g₀₁ are complex polynomials.

16. The apparatus according to claim 12, wherein the key B has a matrix structure, and the signature generation matrix is determined based on the matrix product B.B*, wherein B* is the adjoint matrix of B.

17. The apparatus according to claim 12, wherein the key B has a matrix structure, and the signature generation matrix is determined based on the matrix product \hat{B}.\hat{B}*, wherein \hat{B}* is the adjoint matrix of \hat{B}, and wherein \hat{B} is obtained based on a transform of the matrix B in a frequency domain.

18. The non-transitory computer-readable medium according to claim 13, wherein the memory buffer is dimensioned for storing complex non-diagonal coefficients and real diagonal coefficients of the signature generation matrix SG.

19. The non-transitory computer-readable medium according to claim 13, wherein the diagonal matrix D is of the form
$$( \begin{matrix}{d}_{00} & 0 \\ 0 & {d}_{11}\end{matrix} )$$
and is determined as:
$$( \begin{matrix}{g}_{00} & 0 \\ 0 & {g}_{11} - \frac{\vert {g}_{01} {\vert}^{2}}{{g}_{00}}\end{matrix} ) ,$$
wherein the signature generation matrix SG is of the form
$$( \begin{matrix}{g}_{00} & {g}_{01} \\ {g}_{10} & {g}_{11}\end{matrix} ) ,$$
where g₀₀ and g₁₁ are real polynomials, and g₁₀ and g₀₁ are complex polynomials.

20. The non-transitory computer-readable medium according to claim 13, wherein the key B has a matrix structure, and the signature generation matrix is determined based on the matrix product B.B*, wherein B* is the adjoint matrix of B.
